(19) United States
(12) Patent Application Publication
(10) Pub. No.: US 2006/0262304 A1
(43) Pub. Date: Nov. 23, 2006

(54) Apparatus for automated real-time material identification

(76) Inventor: Keith Carron, Centennial, WY (US)

Correspondence Address: Davis, Brown, Koehn,;Shors & Roberts, P.C., The Financial Center, 666 Walnut Street, Suite 2500, Des Moines, IA, 50309-3993, US

(21) Appl. No.: 11/409,857

(22) Filed: Apr. 24, 2006

Related U.S. Application Data
(60) Provisional application No. 60/674,122, filed on Apr. 22, 2005.

(51) Int. Cl. G01J 3/28

(52) U.S. Cl. 356/328

(57) ABSTRACT

An apparatus is described for the real-time identification of one or more selected components of a target material. In one embodiment, an infrared spectrometer and a separate Raman spectrometer are coupled to exchange respective spectral information of the target material preferably normalized and presented in a single graph. In an alternative embodiment, both an infrared spectrometer and a Raman spectrometer are included in a single instrument and a common infrared light source is used by both spectrometers. In another embodiment, a vibrational spectrometer and a stoichiometric spectrometer are combined in a single instrument and are coupled to exchange respective spectral information of the target material and to compare the spectral information against a library of spectra to generate a real-time signal if a selected component is present in the target material.

### BACKGROUND OF THE INVENTION

This application claims priority to U.S. Provisional Patent Application Ser. No. 60/674,122, filed Apr. 22, 2005.

The invention relates generally to instruments for measuring the spectra of molecules and, more specifically, to the combination of multiple spectroscopic techniques into one instrument to produce multispectral data and the utilization of that data to produce automated real-time material identification.

Spectroscopies that are used in combination to better identify an unknown are sometimes called orthogonal techniques. This is incorrect in the strict sense of the term orthogonal; as it implies that a sum of the two spectra would lead to a null answer or that they statistically independent. In spectroscopy this term is used more loosely to imply two techniques that contain information about a sample that may be different enough to provide better distinction between two known materials.

Currently, vibrational spectroscopy can be performed by two distinct methods: Raman spectroscopy and infrared spectroscopy. A Raman spectrum is a plot of the radiant energy, or number of photons, scattered by a sample through the direct interaction between the molecular vibrations in the sample and the monochromatic radiation's interaction with a molecule's polarizability. An infrared spectrum is a plot of the radiant power resulting from the absorption of infrared radiation with a sample plotted against the wavelength, wavenumber, or frequency. Instruments have long been available for separately measuring the Raman and infrared vibrational spectra of samples.

Depending on the symmetry of the molecule the spectral information related to the energy of a vibration may overlap or it can be completely complementary. The intensity of the spectral features also may be complementary. Raman spectroscopic intensities require changes in polarizability and infrared intensities depend on dipole moment changes. Generally, dipole changes are associated with vibrations that do not involve large changes in polarizability and vice versa.

In general chemical identification can be divided into two classes: elemental analysis and molecular analysis. Elemental analysis describes the atomic composition of a sample. For example, C₈H₁₀ represents the elemental composition of a class of aromatic compounds known as xylene. Molecular analysis describes how the elements are collectively attached to each other. For example, the compound xylene actually consists of three unique molecular structures called ortho-xylene, meta-xylene, and para-xylene. In this case, elemental analysis and molecular analysis are very powerful orthogonal techniques for the exact identification of conformation of xylene.

There are other instruments in common use that provide atomic data from a sample. One example is an atomic emission analyzer based on heating the sample to extreme temperatures. Another is a Laser Induced Breakdown Spectrometer (LIBS). LIBS is a spectroscopic technique that produces emissions from the focal point of a very intense laser and those are detected by a spectrometer. Another spectroscopic method used to provide molecular structure information is Stimulated Raman Scattering (SRS). As with LIBS, SRS is spectroscopic technique that creates an emission of radiation that is detected with a spectrometer. Yet another spectroscopic technique is molecule luminescence spectroscopy. Luminescence spectroscopy is popular for its relatively high sensitivity, yet suffers from fairly low specificity. Fluorescence spectroscopy often requires an additional orthogonal method to accurately identify materials.

There is a need for instrumentation that will simultaneously acquire the total emission spectrum of a sample and combine it with other spectroscopic data to provide a method of conducting real-time material identification.

### SUMMARY OF THE INVENTION

The invention consists of a single instrument that combines two or more spectroscopic techniques to conduct real-time material identification of a sample. The instrument may include vibrational spectroscopic techniques, such as infrared spectroscopy, Raman spectroscopy (normal, stimulated, resonance and surface-enhanced), or luminescence spectroscopy in combination with each other or with other spectroscopic techniques for providing stoichiometric data, such as Laser Induced Breakdown Spectroscopy (LIBS) or atomic emission spectroscopy. The instrument simultaneously acquires multiple spectra and compares them with a library of spectra in a database. By combining multiple spectroscopic techniques into data in a single instrument, it is possible to conduct real-time material identification on a wide variety of samples.

### BRIEF DESCRIPTION OF THE DRAWINGS

FIG. 1 is a graphical representation of the differences between infrared (IR) and Raman spectroscopy (R).

FIG. 2 is a graphical representation of the differences in selection rules for a centrosymmetric molecule.

FIG. 3 is a schematic illustration of the concept of Total Vibrational Spectroscopy.

FIG. 4 is a schematic diagram of a general design of a combined IR and Raman spectrometer.

FIG. 5 is a schematic diagram of an instrument representing a preferred embodiment of the present invention wherein a Stimulated Raman Scattering spectrometer and a Laser Induced Breakdown Spectrometer are combined in a single instrument particularly useful in identifying improvised explosive devices (IEDs).

FIG. 6 is a schematic diagram of a multiple order spectroscopic technique applicable in the present invention.

### DETAILED DESCRIPTION OF THE PREFERRED EMBODIMENTS

The simplest form of the present invention uses two distinct devices to perform Raman spectroscopy and to perform infrared spectroscopy. The devices are in communication with each other to exchange the respective spectral information collected by each device, such as by wireless communication or other means of data transfer. The data is normalized prior to coupling. The coupled instruments will produce a single spectrum with infrared data normalized to have the highest peak at 1 and the highest Raman peak at 1.

A more economical, and perhaps convenient, embodiment of the invention consists of the coupling of the two vibrational spectra techniques into one device. Infrared spectroscopy occurs at fixed energies and is currently performed with multiplex detection. Most common is Fourier Transform spectroscopy, but Hadamard Transform has also been suggested. These transform techniques take advantage of a well-known aspect of infrared spectroscopy. Infrared detectors used in infrared spectrometers are noisy due to the low energy of an infrared photons being detected. Sensitivity is described as the ratio of the spectroscopic signal to the noise in the spectrum. Transform techniques produce the best signal to noise by making the signal big, because the noise cannot practically be reduced. Both Fourier Transform and Hadamard Transform place most of the signal on the detector at one time. The spectrum is formed by measuring the interference pattern and transforming that pattern back into a spectrum.

Traditionally, Raman spectroscopy is performed in the visible region of the electromagnetic spectrum. The photons in this region possess much higher energies than the infrared photons. In this case, the photons are actually counted individually by the detector. When this is the case, the noise is said to be shot noise limited. When a detector is shot noise limited, the noise increases by the square root of the signal. Using a transform technique for visible photons actually decreases the sensitivity or signal to noise. This is because the noise increases with increase in the signal. However, a practical aspect of Raman spectroscopy makes it better to perform Raman spectroscopy in the near infrared. This practicality stems from elimination of fluorescence backgrounds when near infrared excitation is used. This concept has been brought to practice by the Fourier Transform Raman spectrometer. This type of Raman system uses a near infrared laser source and a Michelson interferometer to create a spectrum from the Raman emission. The second component of this invention is the combination of infrared absorption spectroscopy with a broadband IR source and a Raman spectrometer with a laser source within one detection system. As detectors differ for the spectral region used in infrared spectroscopy and those for near-infrared Raman a simple beamsplitter could be used to separate the two regions of radiation. The detectors will be “blind” the each other; preventing interference.

The advantages are that more information is contained in the resulting total vibrational spectrum. The additional information takes the form of new spectral features and/or information in the relative intensity of the bands. Additionally, it is very common for infrared spectra to begin at 500 to 600 wavenumbers due to the absorption of the container material (usually KBr). Raman spectroscopy, on the other hand, can easily start at 200 wavenumbers or less. The total vibrational spectrum thus covers a larger range. When the second aspect or preferred embodiment of this invention is considered the device measures both Raman and infrared spectra with similar costs of a single infrared spectrometer. Thus, it has a significant cost savings. The single channel detector will also provide a method to modulate the detection. Modulation of the detection at the same frequency as the source is an effective method for removal of interfering radiation. A particularly useful application would be acquisition of spectra in bright light conditions such as sunlight. For example, an application of vibrational spectroscopy is to detect material at a distance from a spectrometer in a daylight situation.

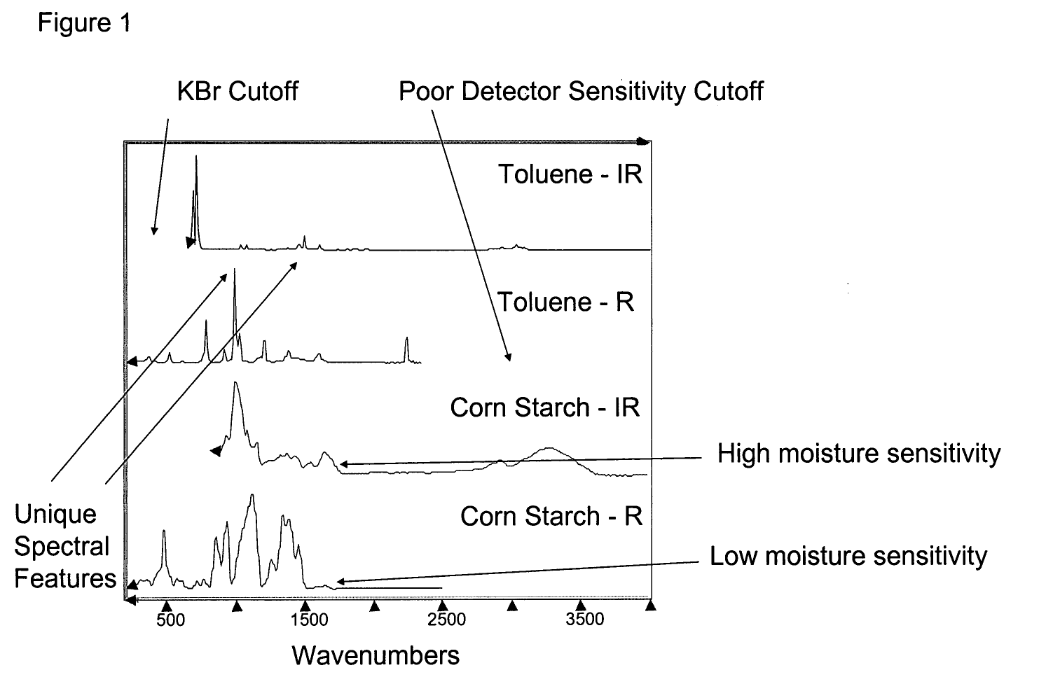

FIG. 1 is a graphical reperesentation of the differences between infrared (IR) and Raman spectroscopy (R). Spectra of toluene and corn starch are shown. The IR spectra are truncated at low wavenumbers due to the absorption of the matrix (KBr) and the Raman spectra are truncated at high wavenumbers due to the low detector efficiency. Both sets of spectra show different spectral features due to the selection rules and the differences in intensity. The corn starch spectra show the stark difference in sensitivity to water (moisture).

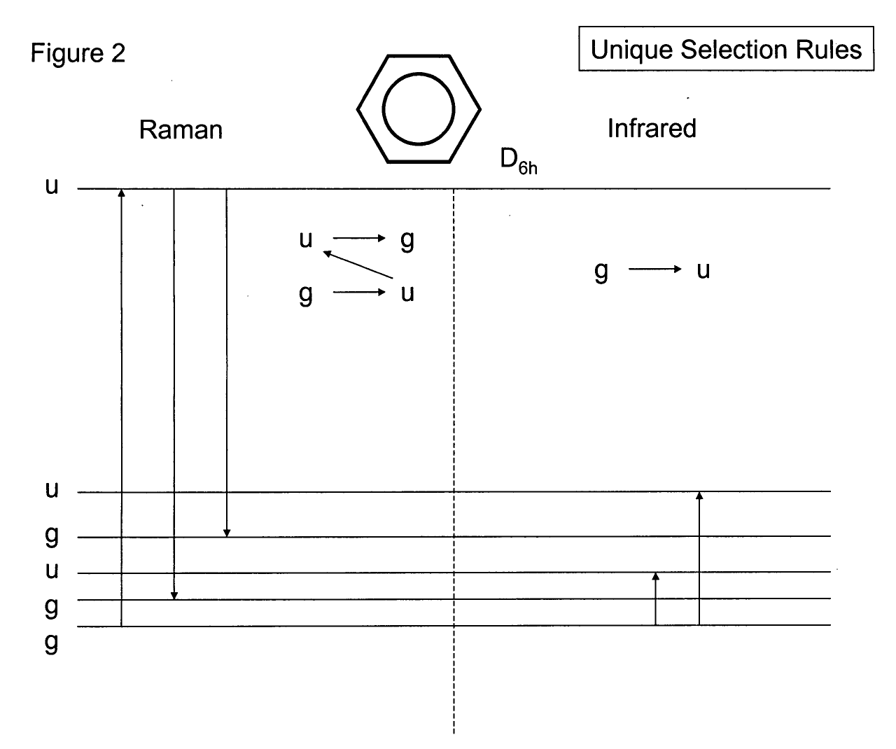

FIG. 2 is a graphical representation of the differences in selection rules for a centrosymmetric molecule. The labels g and u correspond to the parity of the vibrational state. Only vibrations with parity of g are Raman active and only states of u parity are IR active. Even when molecules are not centrosymmetric Raman and infrared can have different selection rules that arise from the dependence of the change in dipole in the case of IR and the change in polarizabilty in case or Raman.

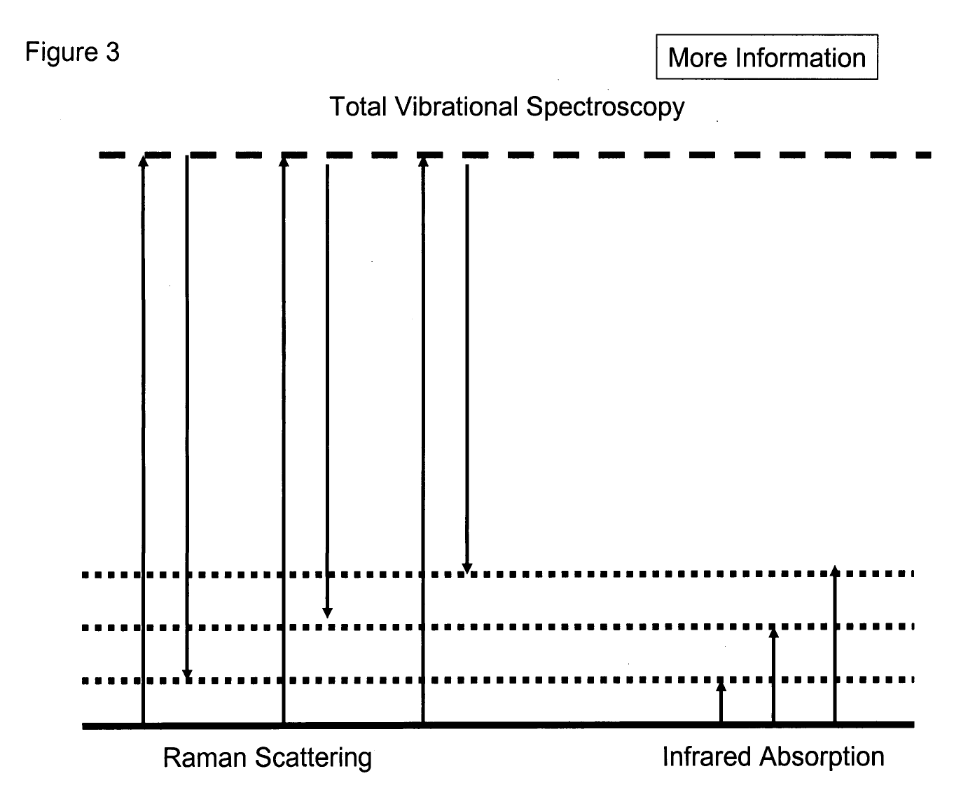

FIG. 3 illustrates the concept of Total Vibrational Spectroscopy. More information is gained by combining IR and Raman spectra. This greater information content is important for the identification of molecules from their vibrational spectrum.

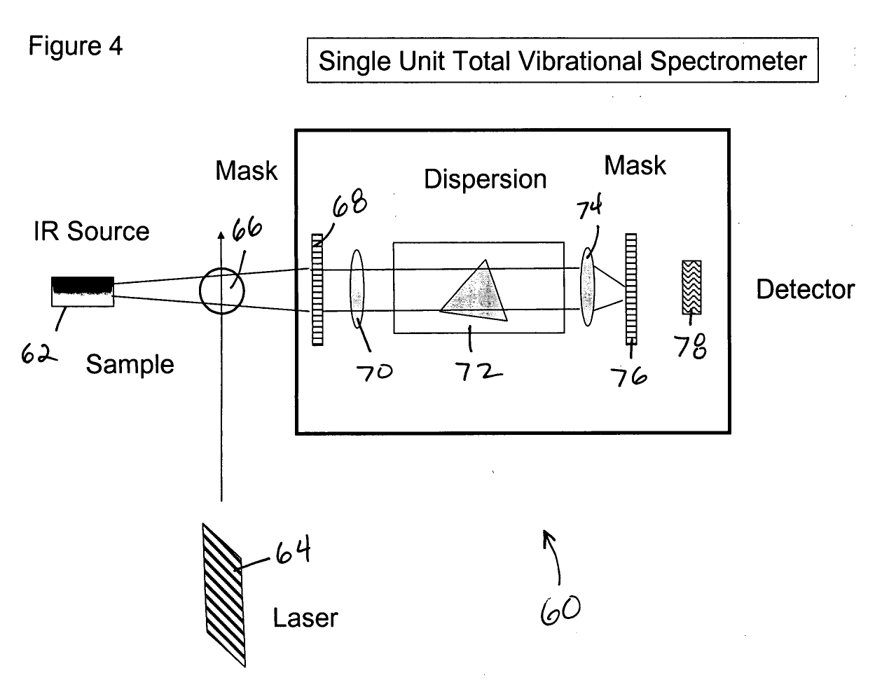

FIG. 4 is a schematic diagram of a general design of a combined IR and Raman spectrometer, indicated generally at 60. This design represents a dual source system (an IR source 62 and a laser source 64 for Raman spectroscopy) and a single dispersive system and digital transform technology coupled with a detector sensitive to both the Raman and the IR wavelengths. Light from both sources 62 and 64 is directed on the sample 66. Light from the sample 66 passes through a mask 68 and collimating lens 70 which directs it through a dispersion element 72. Light from the dispersion cell 72 goes through a focusing lens 74 and a second mask 76 to a detector 78. Key to this design is near-IR laser sources that place the Raman spectrum at wavelengths that overlap with the infrared spectrum to allow a single detector to be used.

In addition to the combination of infrared and Raman spectroscopy it is possible to combine other spectroscopic techniques. The combination of multiple spectroscopic techniques into one instrument will produce multispectral data that is used to produce more accurate automated real-time material identification.

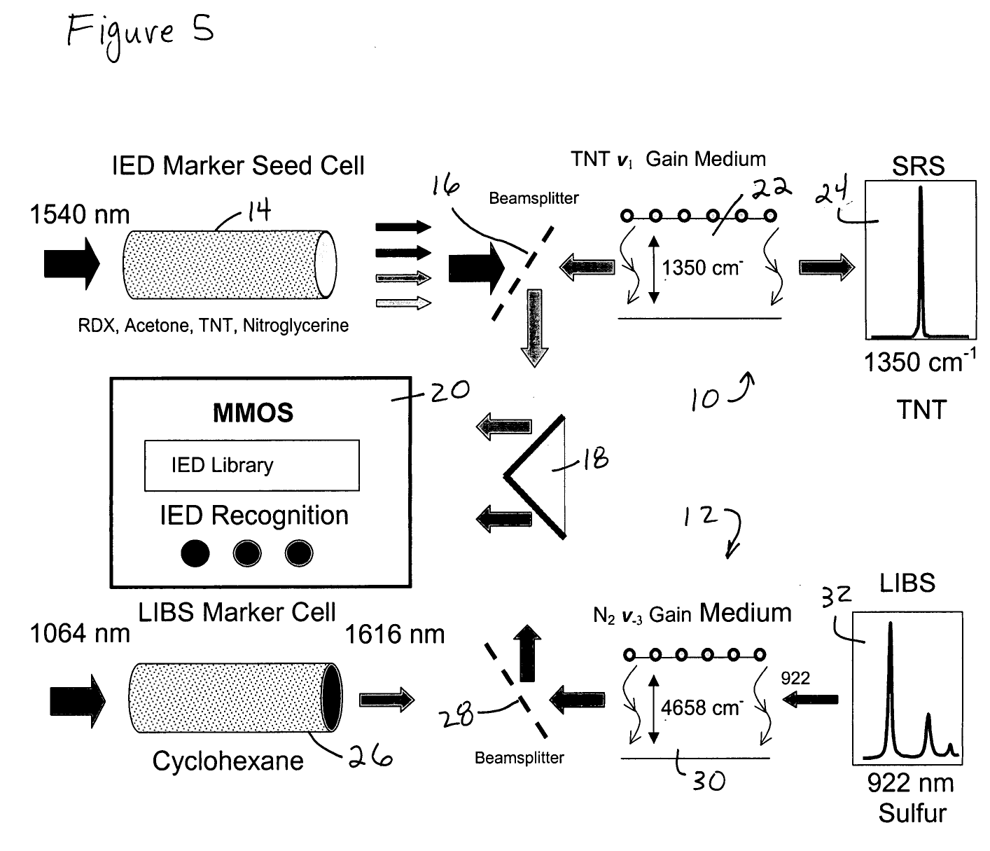

An alternative preferred embodiment of the present invention is a combination of molecular and atomic data from a sample. This might performed by an atomic emission analyzer and an infrared spectrometer. In the prior art, these are two distinct instruments. However, preferred embodiments of the present invention make use of a technique that determines the elemental composition of a sample and its vibrational spectrum simultaneously. A preferred embodiment that combines Stimulated Raman Spectroscopy (SRS) and Laser Induced Breakdown Spectroscopy (LIBS) is illustrated in FIG. 5. In this approach a Laser Induced Breakdown Spectroscopy (LIBS) is used to provide the elemental stoichiometric data. LIBS is a spectroscopic technique that uses a pulsed laser to create a plasma plume of the target material that produces emission from atomic constituents of the material that are detected by a spectrometer. LIBS spectroscopy allows for stoichiometric analysis of the target material. FIG. 5 also shows a molecular spectroscopic method, Stimulated Raman Scattering (SRS), to provide molecular structure information. As with LIBS, SRS, is spectroscopic technique that creates an emission of radiation that is detected with a spectrometer. It is possible to combine the two techniques into one instrument.

When the data is combined it can be placed in a “library” and the library can be searched to match an unknown with a library. A universal analytical technique for chemical analysis does not exist. For example, Raman scattering works very well for organic samples. LIBS works very well for samples that contain elements other than carbon, nitrogen, and oxygen. If a material contains, for example, sulfur, it would be best analyzed by a combination of LIBS and Raman.

Referring to FIG. 5, there is illustrated in block diagram form a preferred embodiment of the invention particularly useful in the identification of explosive devices. The instrument includes a Stimulated Raman Scattering spectrometer 10 and a Laser Induced Breakdown Spectrometer (LIBS) 12. Light from an IED Marker Seed Cell 14 of the SRS spectrometer 10 is divided by a beamsplitter 16. Part of the light is directed to a mirror 18 which reflects it into a MEMS Multiple Order Spectrometer 20. Part of the light is transmitted into TNT ν₁ gain medium 22. Light transmitted though the gain medium 22 is used to generate an SRS peak, which in the case of TNT is a sharp peak at 1350 cm⁻¹ as shown at 24. Light reflected from the gain medium 22 gets directed to the MMOS 20 by the beamsplitter 16 and the mirror 18. Similarly, light from a LIBS Marker Cell 26 of the LIBS spectrometer 12 is divided by a beamsplitter 28. Part of the light is directed to the mirror 18 that reflects it into the MMOS 20. Part of the light is transmitted into N₂ ν₋₂ gain medium 30. Light transmitted though the gain medium 30 is used to generate an LIBS peak, which in the case of sulfur has a characteristic spectrum as shown at 32. Light reflected from the gain medium 30 gets directed to the MMOS 20 by the beamsplitter 16 and the mirror 18.

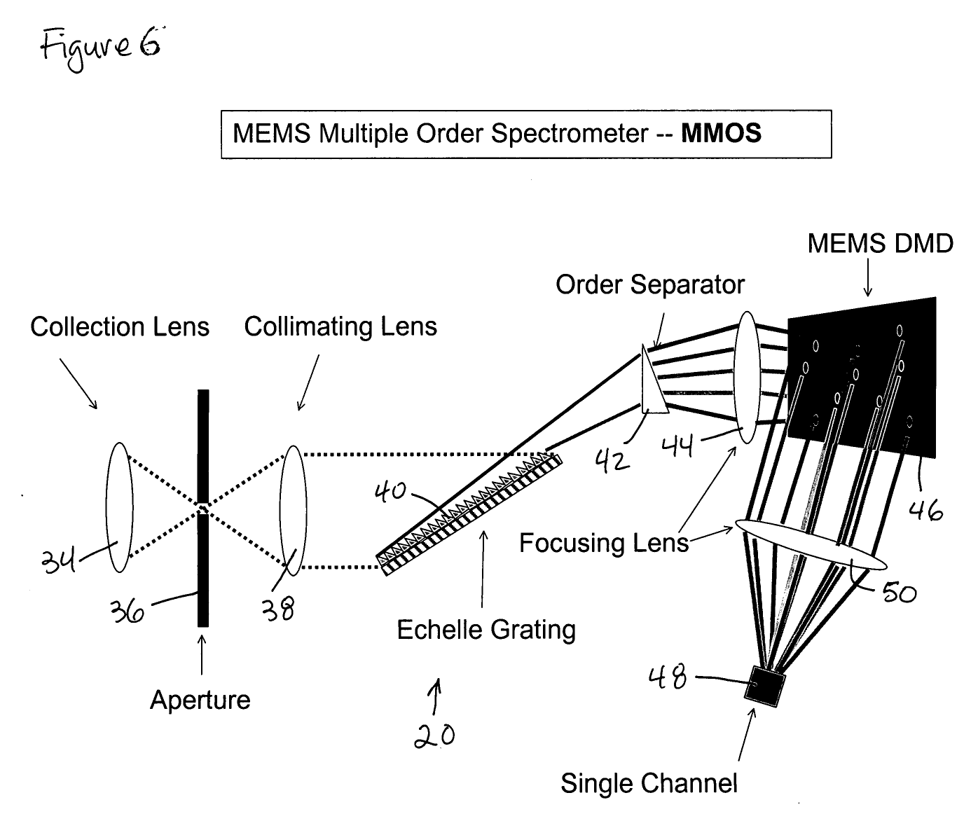

A schematic diagram of the MMOS 20 of a preferred embodiment is illustrated in FIG. 6. Light from the mirror 18 (FIG. 5) is directed through a collection lens 34, an aperture 36 and a collimating lens 38. The light is then refracted by an echelle grating 40 onto an order separator 42 and through a focusing lens 44. The light is directed onto a microelectromechanical (MEM) digital micromirror device (DMD) array 46 that then directs it to a single channel detector 48 through a focusing lens 50. The spectra formed by the light from the target material is compared by a digital computer against a sample spectra library stored in a digital memory device of the MMOS 20 and a signal generated indicating the identification of a selected material, which in the preferred embodiment is an explosive material such as RDX, TNT, or nitroglycerin.

This approach of the present invention is adaptable to spectroscopic methodologies that emit radiation that can be detected with a single type of detector. For example, you cannot combine microwave spectra with spectra formed from visible light. But two techniques that use similar regions of the electromagnetic spectrum can be detected. These are Raman spectroscopies (normal, stimulated, resonance, and SERS), atomic emissions, or fluorescence. The spectrometer shown in FIG. 6 collects data from any type of spectroscopy and processes the information from multiple spectral techniques. For example, individual spectral elements can be processed to produce a signal or the whole spectrum can be created by transforming the array data into a spectrum using techniques similar to or equivalent to Hadamard transformations.

A particular application for the new spectrometer is in the detection of improvised explosive devices (IEDs) used by terrorists. The present instrument can be set to detect those specific, selected elements of the sample spectrum that are required to identify an IED and continuously monitor just those wavelengths. The instrument would be very rapid and provide a signal that would be at least a few orders of magnitude larger than that of prior art systems.

A second embodiment of the present invention is for spectrometers used in Raman spectroscopy. Commercial instruments may use an echelle grating and a 2-dimensional CCD to obtain high-resolution Raman spectra with a small footprint. Replacement of the CCD detector with a the above-described MEMS DMD array and detector would provide similar advantages as in the LIBS spectrometer application, including the ability to monitor specific Raman bands without the time required to read-out the entire CCD chip.

It is difficult to synchronize the readout process of array detectors with a modulated excitation source. This precludes many signal to noise enhancing methods, such as lock-in amplifier detection or gated integrator detection. The spectrometer described in the present invention can direct elements of the spectrum at the single channel detector to enable one to perform synchronous detection.

Synchronous detection is very important for application where solar radiation is present. Asynchronous detection is unable to remove the constant interference presented by solar radiation. The device described herein can remove solar radiation by detecting light only at the modulation frequency of the source.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

I claim:

1. Apparatus combined in a single instrument for measuring a plurality of spectra of a sample, comprising:
(a) a dispersive component;
(b) a focusing element that focuses light from the dispersive component at a focal point;
(c) a two-dimensional array of mirrors at the focal point; and
(d) a single element detector which receives light form the two-dimensional array of mirrors.

2. Apparatus as defined in claim 1, wherein the dispersive element comprises an echelle grating and order separator to disperse the spectrum in two dimensions.

3. Apparatus as defined in claim 1, wherein the detector comprises a digital memory device in which is stored a library of sample spectra and a digital computer for comparing a sample spectrum against the library.

4. Apparatus as defined in claim 1, further comprising a sources of electromagnetic radiation directed on the sample which emits light spectra characteristic of the sample, and wherein the light spectra comprises molecular and elemental emission spectra.

5. An apparatus of claim 4 wherein the molecular spectra is selected from the group consisting of luminescence, Raman, resonance Raman, surface enhanced Raman, and stimulated Raman spectroscopies.

6. An apparatus of claim 4 wherein the elemental spectra is selected from the group consisting of LIBS, atomic emission, and atomic fluorescence spectroscopies.

7. Apparatus combined in a single instrument for measuring a plurality of spectra of a sample, comprising:
(a) a single sampling port;
(b) a first spectrometer for generating a first spectrum and a second spectrometer for generating a second spectrum; and
(c) a communication link between the spectrometers to combine the first and second spectra into a single spectrum.

8. Apparatus as defined in claim 7, further comprising a detector including a digital memory device in which is stored a library of sample spectra and a digital computer for comparing the single spectrum against the library.

9. Apparatus as defined in claim 7, wherein the first spectrum collected and analyzed is a molecular emission spectrum and the second spectrum collected and analyzed is an elemental emission spectrum.

10. Apparatus of claim 9, wherein the molecular spectrum is selected from the group consisting of luminescence, Raman, resonance Raman, surface enhanced Raman, and stimulated Raman spectroscopies

11. Apparatus of claim 9, wherein the elemental spectrum is selected from the group consisting of LIBS, atomic emission, and atomic fluorescence spectroscopies.

12. Apparatus as defined in claim 1, wherein the detector normalizes each of the spectra and combines them to produce a single spectrum containing more information that the individual spectra.

13. Apparatus as defined in claim 8, wherein the detector normalizes each of the spectra and combines them to produce a single spectrum containing more information that the individual spectra.
